(19) United States
(12) Patent Application Publication
(10) Pub. No.: US 2026/0066604 A1
(43) Pub. Date: Mar. 5, 2026

(54) INTEGRATED LINE AMPLIFIER

(71) Applicant: Lumentum Operations LLC, San Jose, CA (US)

(72) Inventor: Josh P. KEMP, Ottawa (CA)

(21) Appl. No.: 18/966,945

(22) Filed: Dec. 3, 2024

Related U.S. Application Data
(60) Provisional application No. 63/687,957, filed on Aug. 28, 2024.

(51) Int. Cl. H01S 3/067; H01S 3/094; H01S 3/16

(52) U.S. Cl. CPC H01S 3/06737; H01S 3/06716; H01S 3/0675; H01S 3/094007; H01S 3/094011; H01S 3/094069; H01S 3/1608; H01S 3/1618

(57) ABSTRACT

In some implementations, a multi-core fiber amplifier includes a set of fiber cores, wherein the set of fiber cores are arranged within a multi-core fiber, a multi-mode pump laser coupled to the multi-core fiber, wherein the multi-mode pump laser is configured to provide a gain on cores of the multi-core fiber; and a set of out-of-band signal sources coupled to the multi-core fiber, wherein each signal source, of the set of out-of-band signal sources, is coupled to a corresponding core of the multi-core fiber, and wherein a signal source, of the set of out-of-band signal sources, is configured to limit the gain, provided by the multi-mode pump laser, on a corresponding core of the multi-core fiber.

### CROSS-REFERENCE TO RELATED APPLICATION

This Patent Application claims priority to U.S. Provisional Ser. No. 63/687,957, filed on Aug. 28, 2024, and entitled “GAIN CONTROLLED INTEGRATED LINE AMPLIFIER. ” The disclosure of the prior Application is considered part of and is incorporated by reference into this Patent Application.

### TECHNICAL FIELD

The present disclosure relates generally to amplifiers and to an integrated line amplifier for multi-rail systems.

### BACKGROUND

Optical amplifiers may be used for a variety of optical applications. For example, optical amplifiers may be used to amplify an optical signal for a sensing application, a communication application, a medical technology application, or a manufacturing application, among other examples. A multi-core fiber (MCF) can be used to increase a capacity of an optical system, such as for a communications application. Multi-core erbium-doped fiber amplifiers (MC-EDFAs) may be used to provide multi-core fiber operations with amplification, thereby achieving high-capacity communication over long distances.

### SUMMARY

In some implementations, an integrated line amplifier includes a set of multi-core fiber amplifiers, of a first type, each set comprising: a set of fiber cores in a multi-core fiber, a multi-mode pump laser coupled to the multi-core fiber, and a set of out-of-band signal sources coupled to the multi-core fiber; a set of fiber amplifiers of a second type; and a set of dynamic gain equalizers (DGEs), wherein the integrated line amplifier includes a set of optical paths associated with a set of directions, and wherein an optical path, of the set of optical paths, includes a first fiber amplifier, of the set of multi-core fiber amplifiers of the first type, coupled to an input of a second fiber amplifier, of the set of fiber amplifiers of the second type, coupled to an input of a DGE, of the set of DGEs, coupled to an input of a third fiber amplifier, of the set of fiber amplifiers of the second type, coupled to an input of a fourth fiber amplifier, of the set of first type of multi-core fiber amplifiers.

In some implementations, a multi-core fiber amplifier includes a set of fiber cores, wherein the set of fiber cores are arranged within a multi-core fiber, a multi-mode pump laser coupled to the multi-core fiber, wherein the multi-mode pump laser is configured to provide a gain on cores of the multi-core fiber; and a set of out-of-band signal sources coupled to the multi-core fiber, wherein each signal source, of the set of out-of-band signal sources, is coupled to a corresponding core of the multi-core fiber, and wherein a signal source, of the set of out-of-band signal sources, is configured to limit the gain, provided by the multi-mode pump laser, on a corresponding core of the multi-core fiber.

In some implementations, an integrated line amplifier includes a first set of fiber amplifiers, wherein the first set of fiber amplifiers are a first type of fiber amplifier, wherein each fiber amplifier, of the first set of fiber amplifiers, includes a set of fiber cores arranged within a multi-core fiber, wherein the integrated line amplifier is arranged in an east-west pattern for the multi-core fiber; a multi-mode pump laser coupled to the multi-core fiber; a set of out-of-band signal sources coupled to the multi-core fiber; and a second set of fiber amplifiers, wherein the second set of fiber amplifiers are a second type of fiber amplifier.

### BRIEF DESCRIPTION OF THE DRAWINGS

FIG. 1 is a diagram of an example implementation associated with a fiber amplifier.

FIG. 2 is a diagram of an example implementation associated with a multi-core fiber.

FIGS. 3A and 3B are diagrams of example implementations associated with integrated line amplifiers.

FIGS. 4A and 4B are diagrams of an example implementation associated with an integrated line amplifier.

### DETAILED DESCRIPTION

The following detailed description of example implementations refers to the accompanying drawings. The same reference numbers in different drawings may identify the same or similar elements.

An optical amplifier may be included in an optical system to amplify an optical signal, such as a beam. For example, in an optical communications system, an optical amplifier may provide gain to an optical beam to enable detection of the optical beam (and decoding of information conveyed thereon) in long-range communications. Doped-fiber amplifiers (DFAs) are a type of optical amplifier in which a doped optical fiber is used as a gain medium for amplification of optical signals. In this case, an optical device may include a pump laser and a signal source, which are combined in a doped fiber. The pump laser provides amplification to the signal source when a first optical beam from the pump laser interacts with a second optical beam from the signal source. One example of a doped-fiber amplifier is an erbium-doped fiber amplifier (EDFA). An EDFA may be selected since an amplification window of an EDFA has a wavelength range that overlaps with a wavelength range of a transmission window of a silica fiber.

As capacity in optical communications systems increases, some optical communications systems may use multi-rail configurations. In a multi-rail configuration, multiple parallel fiber pairs may be arranged to provide communications pathways for multiple optical beams. A set of EDFAs may be provided in such an optical communications system to provide amplification for multiple fibers in a multi-rail configuration. However, such amplification arrangements may be inefficient, resulting in high power utilization to provide amplification across the multiple fibers. Further, amplification may be cross-dependent on different fibers. In other words, when a set of EDFAs are used to provide amplification in a multi-rail configuration, amplification in a first fiber may be dependent on amplification in a second fiber. This may result in poor deployment flexibility and/or communication performance. Furthermore, as a density of optical fibers increases, amplification for the optical fibers may result in excessive crosstalk between optical fibers, which may result in excessive error rates, dropped communications, and/or poor performance.

Some implementations described herein provide an integrated line amplifier for a multi-rail optical system. For example, some implementations described herein use a multi-core erbium-ytterbium-doped fiber (MC-EYbDF) to provide amplification of multiple optical fibers in an optical communications system. In this way, the integrated line amplifier may provide independent gain control to each rail (e.g., each fiber) of a multi-rail system. In some implementations, an integrated line amplifier may include a first type of cladding pumped multi-core active fiber amplifier, such as an MC-EYbDF amplifier, and a second type of multi-core fiber amplifier, such as an EDFA. In this way, by including multiple types of amplifiers within an integrated line amplifier, the integrated line amplifier may achieve higher efficiency than other configurations. In some implementations, an integrated line amplifier may include a set of channels that are arranged to achieve east-west separability, as described in more detail herein. In this way, the integrated line amplifier may provide additional deployment flexibility.

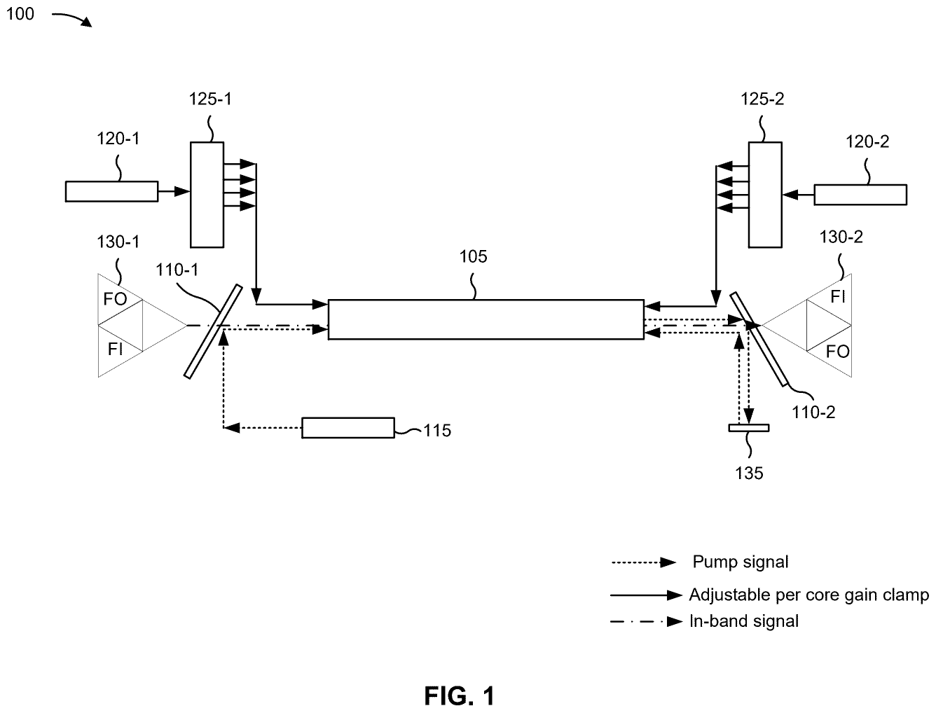

FIG. 1 is a diagram of an example amplifier 100 within an integrated line amplifier. As shown in FIG. 1, the amplifier 100 includes a multi-core fiber 105, a set of optical elements 110 (e.g., a first optical element 110-1 and a second optical element 110-2), a multi-mode pump 115, a set of out-of-band (OOB) signal sources 120 (e.g., a first OOB signal source 120-1 and a second OOB signal source 120-2), a set of semi-conductor optical amplifier (SOA) splitter assemblies 125 (e.g., a first SOA splitter assembly 125-1 and a second SOA splitter assembly 125-2), a set of fiber input, fiber output (FIFO) assemblies 130 (e.g., a first FIFO assembly 130-1 and a second FIFO assembly 130-2), and a reflection component 135.

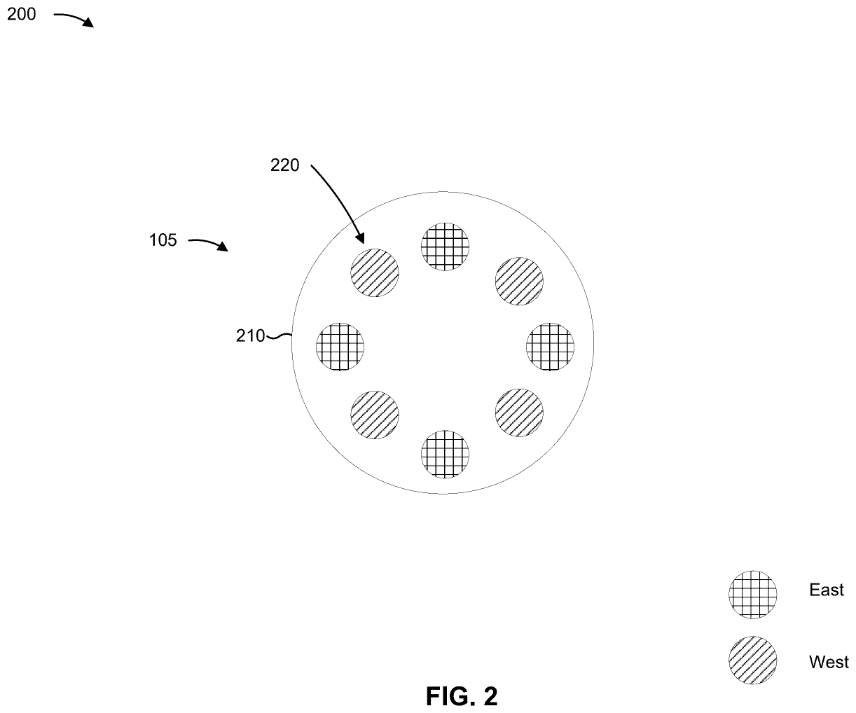

In some implementations, the multi-core fiber 105 may include a set of fiber cores. For example, the multi-core fiber 105 may include multiple fiber cores arranged in a linear arrangement, a circular arrangement, or another type of arrangement. For example, FIG. 2 illustrates a diagram of an example implementation 200 of a multi-core fiber 105. As shown in FIG. 2, the multi-core fiber 105 includes an outer cladding 210 and a set of fiber cores 220. Some fiber cores 220 may be assigned to different directions, which may be referred to as an “east” direction or a “west” direction. In some implementations, the fiber cores 220 may be arranged in an alternating pattern, such that adjacent fiber cores have alternating directions, which may reduce crosstalk relative to having adjacent fiber cores 220 with a same direction. In some implementations, the fiber cores 220 may be disposed in a particular arrangement, such as a circular arrangement, as shown. Additionally, or alternatively, the fiber cores 220 may be disposed in a linear arrangement.

In some implementations, optical element 110 may include a combiner or a splitter. For example, a set of combiners or splitters may combine or split one or more beams. In this case, the set of combiners or splitters may include a free space optic (FSO), a lens, a mirror, a filter, a grating, a microelectromechanical system (MEMS) device, or another type of component. In a first direction, the optical element 110-1 may receive an in-band signal (e.g., from the FIFO assembly 130-1) and a pump signal and direct the in-band signal and the bump signal toward the multi-core fiber 105. By combining the pump signal and the in-band signal, the amplifier 100 may provide a gain to the in-band signal.

In some implementations, the multi-mode pump 115 may be a signal source (e.g., a laser) associated with providing a pump signal. For example, the multi-mode pump 115 may provide a set of pump signals for a set of fiber cores of the multi-core fiber 105. The pump signal may be directed to the set of fiber cores of the multi-core fiber 105 via the optical element 110-1, which may combine the set of pump signals into a respective set of in-band signals that are directed via a respective set of fiber cores.

In some implementations, the OOB signal sources 120 and the SOA splitter assembly 125 may be associated with providing an adjustable per-core gain clamp signal. For example, the OOB signal sources 120 may include a signal laser that provides an OOB signal to the SOA splitter assembly 125. The OOB signal may be configured on a per-core basis. For example, the amplifier 100 (or an EDFA amplifier in line therewith) may adjust an amount of gain that is provided on each core of the multi-core fiber 105. The adjustable per-core gain clamp signal may clamp (or limit) an amount of gain that can be provided on a core to a configured threshold level. The SOA splitter assembly 125 may include one or more electro-optical components, such as a splitter, an SOA, or another optical component. For example, in a 4-rail configuration, the SOA splitter assembly 125 may include a 1×4 splitter to split the OOB signal from an OOB signal source 120. Additionally, or alternatively, the SOA splitter assembly 125 may include a set of SOAs. For example, in the 4-rail configuration, the SOA splitter assembly 125 may include 4 independently-controllable SOAs to adjust a gain from each output of the 1×4 splitter. In this example, the 4 independently-controllable SOAs are coupled to a corresponding set of fiber cores of the multi-core fiber. Although some aspects are described in terms of a 4-rail configuration, another n-rail configuration may be used, which may result in a different type of splitter, such as a 1×5 splitter, a 1×8 splitter, or a 1×16 splitter, among other examples. In some implementations, the SOA splitter assembly 125 may include multiple splitters, such as multiple cascaded 1×2 splitters that achieve a 1×4 split.

In some implementations, the set of FIFO assemblies 130 may include a set of optical inputs and/or outputs associated with the amplifier 100. For example, the FIFO assembly 130-1 may receive an input signal (e.g., an in-band signal) and provide the input signal toward the multi-core fiber 105 for amplification. Similarly, the FIFO assembly 130-2 may receive an output signal from the multi-core fiber 105 (e.g., an amplified and gain controlled signal) and provide the output signal as output. In other words, the multi-core fiber 105 may receive, in the first direction, an adjustable per-core gain clamp signal from the OOB signal sources 120-1 and the SOA splitter assembly 125-1, which may provide gain control for the multi-core fiber 105. The multi-core fiber 105 may output, in the first direction, the in-band signal, which has been amplified and gain controlled as a result of combining with the pump signal and the adjustable per core gain clamp signal.

In some implementations, the reflection component 135 is associated with recovery of excess pump power. For example, some of the pump signal may not be combined onto the in-band signal in connection with a relatively low pump power absorption of the multi-core fiber 105 (e.g., relatively low absorption of MC-EYbDF). Accordingly, the reflection component 135 may reflect some wasted pump signal back into a second direction to reuse some of the wasted pump signal for amplification of the in-band signal in the second direction. In this way, the amplifier 100 obviates or reduces a need for a multi-mode pump associated with the second direction.

In some implementations, sections of the multi-core fiber 105 may have similar gain values. For example, sections of the multi-core fiber 105 may be configured with gain values within a threshold amount, such as within approximately 10% of each other. In this case, based on the sections of the multi-core fiber 105 having similar gain values, the integrated line amplifier, which includes the amplifier 100, may be deployed as an east-west separable optical system. An east-west separable optical system may include an optical system that can be operated as two separate pieces in an east-west pattern. Here, a first part of the integrated line amplifier may correspond to, for example, an east direction (e.g., signals being directed from left to right through the multi-core fiber 105 in FIG. 1) of the east-west pattern. Additionally, or alternatively, a second part of the integrated line amplifier may correspond to, for example, a west direction (e.g., signals being directed from right to left through the multi-core fiber 105 in FIG. 1) of the east-west pattern. Alternatively, when gain values are not similar, the integrated line amplifier may not be deployed as an east-west separable optical system. In this case, the amplifier 100 (e.g., an EYbDFA) may be used to generate all gain within the integrated line amplifier. For example, in a 4-rail configuration, as shown, a single amplifier 100 may be used for providing gain to each core of a 16-core EYbDF multi-core fiber 105. By using a single amplifier 100, additional power consumption reduction may be achieved relative to configurations that use multiple amplifiers 100.

As indicated above, FIGS. 1 and 2 are provided as examples. Other examples may differ from what is described with regard to FIGS. 1 and 2.

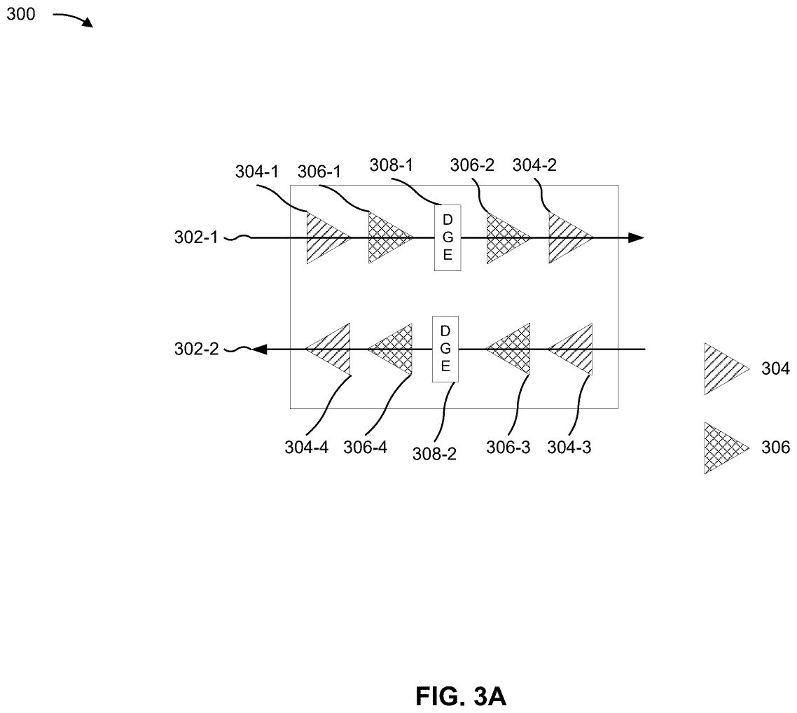

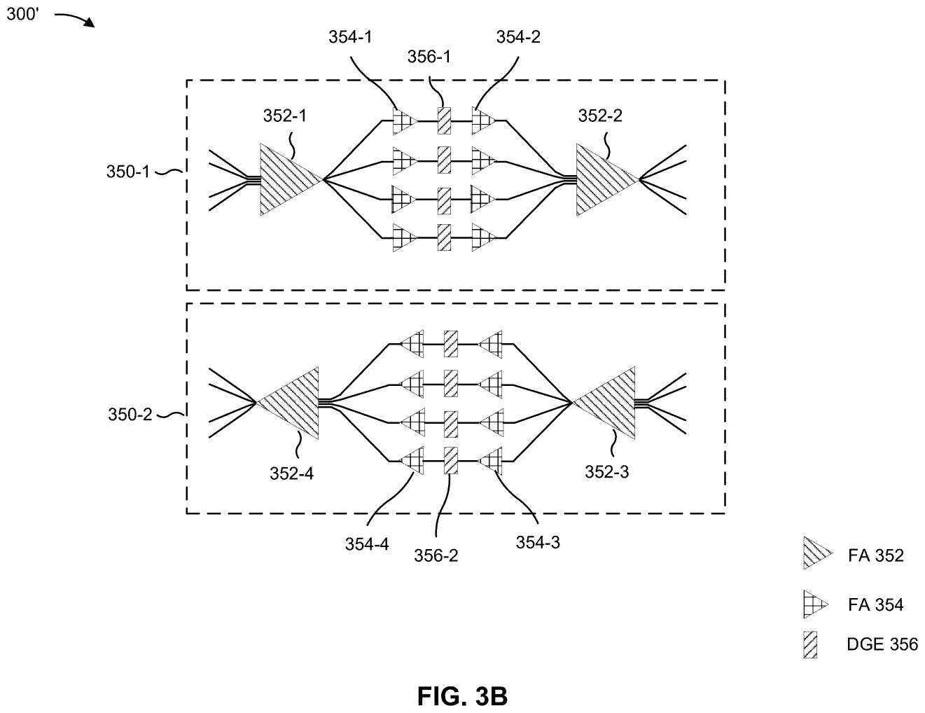

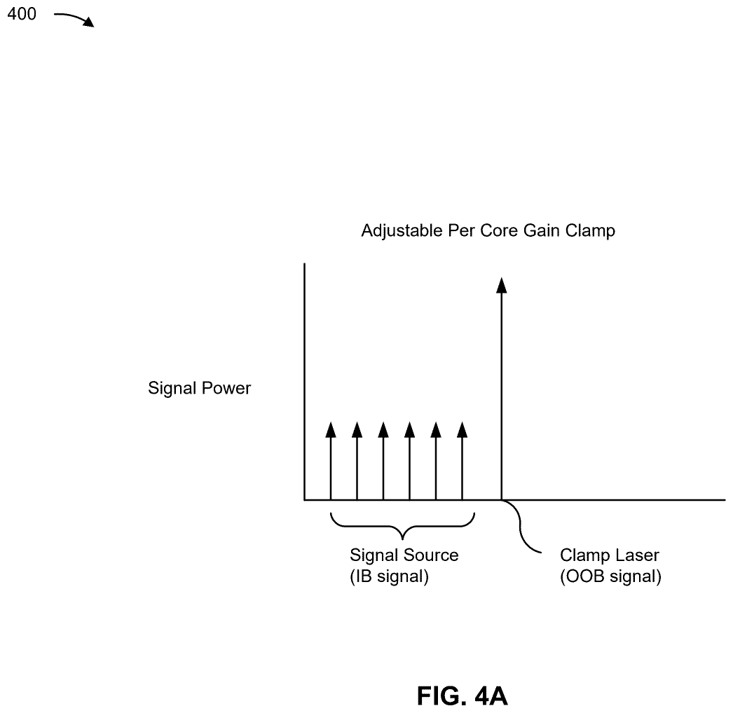

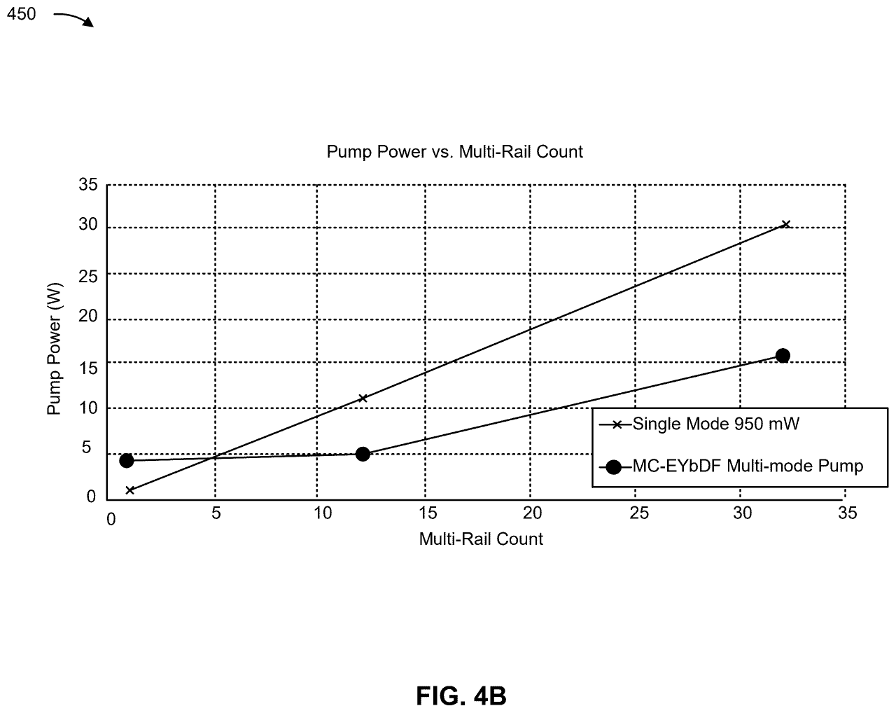

FIGS. 3A and 3B are diagrams of example integrated line amplifiers 300/300′associated with an integrated line amplifier. FIGS. 4A and 4B are diagrams associated with operation of the integrated line amplifiers 300/300′. Integrated line amplifier 300 illustrates a set of optical paths for an n-rail configuration. Similarly, integrated line amplifier 300′illustrates a breakout of amplifiers and optical paths associated with individual gain control in a 4-rail configuration.

As shown in FIG. 3A, integrated line amplifier 300 includes a first optical path 302-1 associated with a first direction and a second optical path 302-2 associated with a second direction. In some implementations, the optical paths 302 are associated with respective sets of fiber cores of a multi-core fiber. For example, as described above, adjacent cores of an MC-EYbDF may be configured to convey opposite direction traffic, thereby reducing cross-talk between cores. In some implementations, the first optical path 302-1 includes an optical path that is directed toward a fiber amplifier 304-1, a fiber amplifier 306-1, a DGE 308-1, a fiber amplifier 306-2, and a fiber amplifier 304-2. In some implementations, the second optical path 302-2 includes an optical path that is directed toward a fiber amplifier 304-3, a fiber amplifier 306-3, a DGE 308-2, a fiber amplifier 306-4, and a fiber amplifier 304-4.

As shown in FIG. 3B, integrated line amplifier 300′includes a first set of optical paths 350-1 associated with a first direction and a second set of optical paths 350-2 associated with a second direction. In some implementations, the first set of optical paths 350-1 includes a set of optical paths that are directed toward a fiber amplifier 352-1, a set of fiber amplifiers 354-1, a set of DGEs 356-1, a set of fiber amplifiers 354-2, and a fiber amplifier 352-2. Similarly, the second set of optical paths 350-2 includes a set of optical paths that are directed toward a fiber amplifier 352-3, a set of fiber amplifiers 354-3, a set of DGEs 356-2, a set of fiber amplifiers 354-4, and a fiber amplifier 352-4.

In some implementations, the DGEs 308/356 provide a spectral control functionality. For example, by providing DGEs 308/356 between the sets of fiber amplifiers 306/354, the integrated line amplifier 300/300′may achieve fast spectral control (e.g., at a rate greater than the megahertz (MHz) range), thereby enhancing gain control. In some implementations, the DGEs 308/356 may include a grating light valve to achieve fast spectral control and/or signal correction. In some implementations, the integrated line amplifier 300/300′may include another type of electro-optic component to perform a spectral control or signal correction functionality. For example, the integrated line amplifier 300/300′may include a variable optical attenuator.

In some implementations, an integrated line amplifier (e.g., the integrated line amplifier 300/300′) may include multiple types of fibers associated with multiple types of fiber amplifiers. For example, the fiber amplifiers 304/352 may include a set of MC-EYbDFAs (e.g., a first type of fiber amplifier) associated with a set of MC-EYbDFs (e.g., a first type of fiber, which may be a multi-core fiber). Additionally, or alternatively, the fiber amplifiers 306/354 may include sets of EDFAs (or MC-EDFAs) (e.g., a second type of fiber amplifier) associated with sets of EDFs (or multi-core (MC) EDFs (MC-EDFs)) (e.g., a second type of fiber, which may be a single-core fiber).

In some implementations, the first type of fiber amplifier is associated with a limited adjustable gain. For example, an out-of-band signal may be added, as described above, to a signal in the first type of amplifier to limit an available gain. In this case, an integrated line amplifier can perform gain control by gain clamping of a signal. For example, an out-of-band laser (e.g., a signal laser that is split and amplified using an SOA splitter assembly) provides the out-of-band signal with a first power level and the out-of-band signal is coupled with an in-band signal at a second power level. In this case, as shown in FIG. 4A, and by diagram 400, the second power level is smaller than the first power level. Accordingly, the out-of-band signal saturates an output power of the first type of fiber amplifier, thereby limiting an amount of gain available to the in-band signal. An output of the first type of fiber amplifier is individually adjustable at the second type of fiber amplifier. In this case, by providing multiple types of fiber amplifiers in stages, the first type of fiber amplifier can provide a larger relative proportion of gain and the second type of amplifier can provide a smaller relative proportion of gain. In this case, by providing a single pump laser for the first type of fiber amplifier (and individual pump lasers for the second type of fiber amplifier), an amount of power consumption can be reduced for the integrated line amplifiers 300/300′ (e.g., relative to a line amplifier with only the second type of fiber amplifier). In other words, as shown in FIG. 4B, and by diagram 450, when a quantity of rails (e.g., cores) is greater than 5, usage of an MC-EYbDF multi-mode pump for the first type of fiber amplifier results in a reduction in pump power used (relative to having multiple single-mode 950 milliwatt (mW) pumps). Accordingly, some integrated amplifiers 300/300′ may be used with 5 or more cores, such as with an 8-core fiber or a 16-core fiber within an MC-EYbDFA thereof. In other examples, fewer cores may be used, such as a 4-core fiber or a 2-core fiber.

In some implementations, only the second type of fiber amplifier provides gain control. For example, cores of the first type of fiber amplifier may not be adjustable (e.g., the first type of fiber amplifier may be configured for the same gain across all cores), resulting in relative gain control (e.g., among the cores and associated optical paths) occurring in the second type of fiber amplifier. In some implementations, both the first type of fiber amplifier and the second type of fiber amplifier provide gain control. For example, cores of the first type of fiber amplifier may be individually adjustable (e.g., a first core may provide a different gain value than a second core), resulting in relative gain control occurring in both the first type of fiber amplifier and the second type of fiber amplifier. By using individually-adjustable cores in the first type of fiber amplifier, more amplification may be shifted from occurring in the second type of fiber amplifier to occurring in the first type of fiber amplifier (relative to a configuration with non-individually-adjustable cores), thereby providing power consumption savings. In this case, using both MC-EYbDFs and EDFs (and the associated fiber amplifiers) may reduce a power usage per bit.

As indicated above, FIGS. 3A and 3B and FIGS. 4A and 4B are provided as examples. Other examples may differ from what is described with regard to FIGS. 3A and 3B and FIGS. 4A and 4B.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z. ”

No element, act, or instruction used herein should be construed as critical or essential unless explicitly described as such. Also, as used herein, the articles “a” and “an” are intended to include one or more items, and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An integrated line amplifier, comprising:
a set of multi-core fiber amplifiers, of a first type, each comprising:
a set of fiber cores in a multi-core fiber,
a multi-mode pump laser coupled to the multi-core fiber, and
a set of out-of-band signal sources coupled to the multi-core fiber;
a set of fiber amplifiers of a second type; and
a set of dynamic gain equalizers (DGEs),
wherein the integrated line amplifier includes a set of optical paths associated with a set of directions, and
wherein an optical path, of the set of optical paths, includes a first fiber amplifier, of the set of multi-core fiber amplifiers of the first type, coupled to an input of a second fiber amplifier, of the set of fiber amplifiers of the second type, coupled to an input of a DGE, of the set of DGEs, coupled to an input of a third fiber amplifier, of the set of fiber amplifiers of the second type, coupled to an input of a fourth fiber amplifier, of the set of multi-core fiber amplifiers of the first type.

2. The integrated line amplifier of claim 1, wherein the set of multi-core fiber amplifiers of the first type includes a cladding pumped multi-core active fiber amplifier.

3. The integrated line amplifier of claim 2, wherein the cladding pumped multi-core active fiber amplifier is a multi-core erbium ytterbium doped fiber amplifier (MC-EYbDFA).

4. The integrated line amplifier of claim 1, wherein the set of fiber amplifiers of the second type includes an erbium-doped fiber amplifier (EDFA).

5. The integrated line amplifier of claim 1, wherein the DGE includes a grating light valve.

6. A multi-core fiber amplifier, comprising:
a set of fiber cores,
wherein the set of fiber cores are arranged within a multi-core fiber,
a multi-mode pump laser coupled to the multi-core fiber,
wherein the multi-mode pump laser is configured to provide a gain on cores of the multi-core fiber; and
a set of out-of-band signal sources coupled to the multi-core fiber,
wherein each signal source, of the set of out-of-band signal sources, is coupled to a corresponding core of the multi-core fiber, and
wherein a signal source, of the set of out-of-band signal sources, is configured to limit the gain, provided by the multi-mode pump laser, on a corresponding core of the multi-core fiber.

7. The multi-core fiber amplifier of claim 6, wherein the multi-mode pump laser is coupled to at least 5 cores of the multi-core.

8. The multi-core fiber amplifier of claim 6, further comprising:
a semi-conductor optical amplifier (SOA) splitter assembly coupled to the multi-core fiber, the SOA splitter assembly comprising:
a set of SOAs; and
a splitter.

9. The multi-core fiber amplifier of claim 8, wherein the SOA splitter assembly is associated with providing the set of out-of-band signal sources.

10. The multi-core fiber amplifier of claim 6, wherein the multi-core fiber includes a first section and a second section,
wherein the first section is associated with a first gain value and the second section is associated with a second gain value.

11. The multi-core fiber amplifier of claim 10, wherein the first gain value is within a threshold amount of the second gain value, such that the multi-core fiber is configured to be east-west separable.

12. The multi-core fiber amplifier of claim 10, wherein the first gain value is not within a threshold amount of the second gain value, such that the multi-core fiber amplifier uses a single multi-core fiber to generate all gain within the multi-core fiber amplifier.

13. The multi-core fiber amplifier of claim 6, further comprising:
a reflection component to reflect the multi-mode pump laser.

14. The multi-core fiber amplifier of claim 6, further comprising:
a fiber coupling to couple to at least one single core fiber amplifier.

15. An integrated line amplifier, comprising:
a first set of fiber amplifiers,
wherein the first set of fiber amplifiers are a first type of fiber amplifier,
wherein each fiber amplifier, of the first set of fiber amplifiers, includes a set of fiber cores arranged within a multi-core fiber,
wherein the integrated line amplifier is arranged in an east-west pattern for the multi-core fiber;
a multi-mode pump laser coupled to the multi-core fiber;
a set of out-of-band signal sources coupled to the multi-core fiber; and
a second set of fiber amplifiers,
wherein the second set of fiber amplifiers are a second type of fiber amplifier.

16. The integrated line amplifier of claim 15, wherein the multi-core fiber is a 4-core, 8-core, or 16-core fiber.

17. The integrated line amplifier of claim 15, wherein the multi-mode pump laser is configured to provide a gain on each core of the multi-core fiber.

18. The integrated line amplifier of claim 15, wherein the set of out-of-band signal sources is configured to limit a gain on the cores of the multi-core fiber.

19. The integrated line amplifier of claim 15, wherein the cores of the multi-core fiber are configured to be individually gain controlled.

20. The integrated line amplifier of claim 15, wherein the east-west pattern comprises a first set of cores, of the multi-core fiber, associated with a first directionality and a second set of cores, of the multi-core fiber, associated with a second directionality.
